(19) United States
(12) Patent Application Publication
(10) Pub. No.: US 2017/0204557 A1
(43) Pub. Date: Jul. 20, 2017

(54) IRONING CENTER

(71) Applicant: DROPOUT CABINET FIXTURES, LLC, Morgan Hill, CA (US)

(72) Inventor: Clinton Merle BUNCH, Morgan Hill, CA (US)

(73) Assignee: DROPOUT CABINET FIXTURES, LLC, Morgan Hill, CA (US)

(21) Appl. No.: 15/410,608

(22) Filed: Jan. 19, 2017

Related U.S. Application Data
(60) Provisional application No. 62/388,171, filed on Jan. 19, 2016.

(51) Int. Cl. D06F 79/02; A47B 46/00; A47B 5/04; D06F 81/06; A47B 88/477; A47B 61/00; F16L 3/06; D06F 81/02; A47B 88/42; A47B 88/437

(52) U.S. Cl. CPC D06F 79/02; A47B 88/42; A47B 46/00; A47B 5/04; A47B 88/437; A47B 88/477; A47B 61/003; F16L 3/06; D06F 81/02; D06F 81/06; D06F 79/023

(57) ABSTRACT

The present invention provides for a complete ironing center to be attached to and stored within a wall cabinet. The ironing board is deployed perpendicularly from the back wall of the cabinet. In one embodiment, the cabinet is integrated into a larger wall cabinet system. In these embodiments, the cabinet is extended from the wall cabinet and locked into an open position. This complete system is easily and quickly closed and stored out of sight within the cabinet when not in use.

### RELATED APPLICATIONS

This application claims priority to U.S. Provisional Application No. 62/388,171, entitled, “Pull-Out Ironing Center,” filed on Jan. 19, 2016. The disclosure of the related application is hereby incorporated by reference in its entirety.

### COPYRIGHT AUTHORIZATION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates generally to ironing board storage systems. More particularly, the invention relates to a cabinet storage system for improving organization, accessibility, space efficiency and convenience of necessary components and accessories for ironing. In one embodiment, the cabinet storage system is a pull-out cabinet.

### BACKGROUND

Built-in ironing centers are a common feature in many homes and have been created in many different configurations over the last century but these generally require clear wall space to be either built into or attached to.

These systems generally contain reduced sized ironing boards and they are often a visually undesirable feature on the wall of the room.

### BRIEF DESCRIPTION OF THE DRAWINGS

FIG. 1 is a perspective view of the ironing center with the ironing board in an extended position.

FIG. 2 is a front view of the ironing center with the ironing board in a folded up position.

FIG. 3 is a side view of the ironing center with the ironing board in a folded up position.

FIG. 4 is a front view of the ironing center with the ironing board in an extended position.

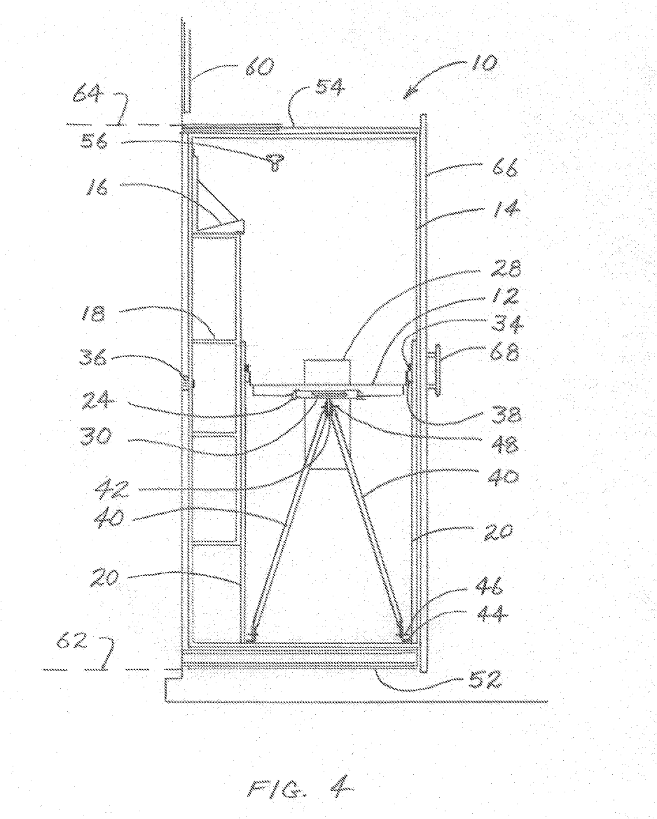

FIG. 5 is a side view of the ironing center with the ironing board in an extended position.

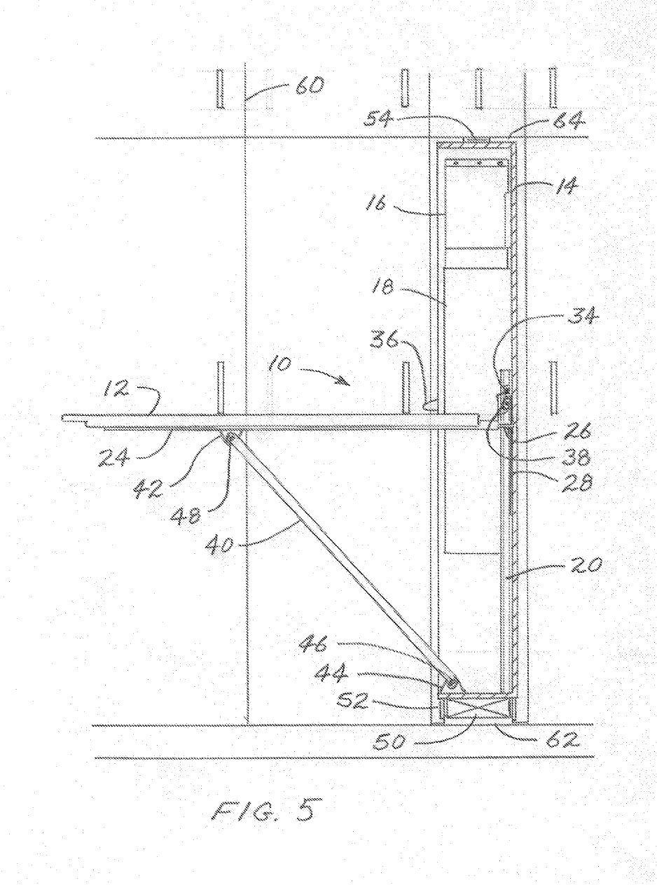

FIG. 6 is a side view of the ironing center with the ironing board in a partially extended position.

### DETAILED DESCRIPTION OF THE INVENTION

Generally the invention provides for a new an esthetically pleasing system for storing and using an ironing board and its associated accompaniments. By residing within a narrow space in a wall cabinet the impact on a room when not in use is negligible. When ironing is needed, access is very easy and quick; and when no longer needed it is just as efficient to put away.

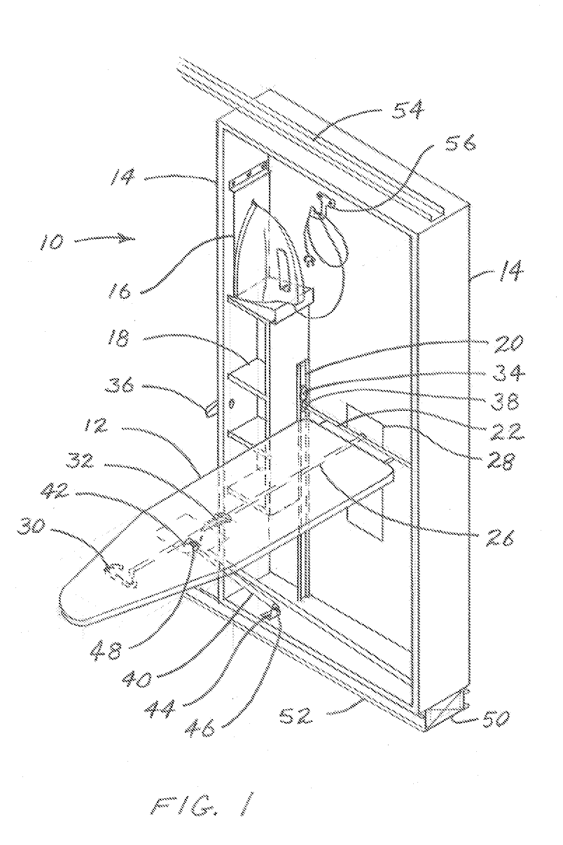

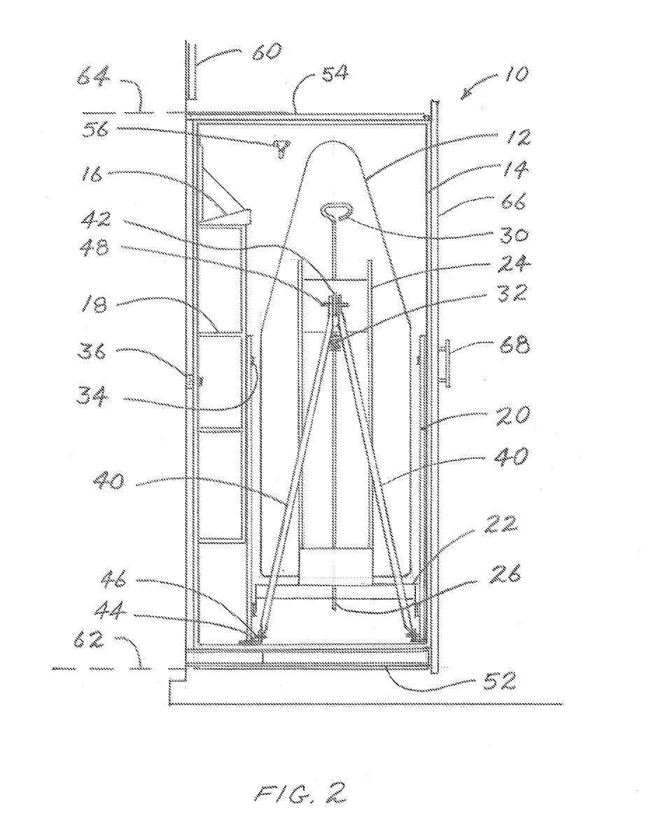

Turning to the figures, FIG. 1 illustrates the ironing center 10. Ironing center 10 includes an ironing board 12 housed within a cabinet 14 which includes one back, two side walls, a top and a bottom. In one embodiment, as illustrated in the figures, cabinet 14 is a pull-out cabinet. In another embodiment, cabinet 14 is mounted to a wall. In the wall mount embodiment, cabinet 14 has a front door(s) to enclose the ironing center. Ironing board 12 has a top side which is used for ironing and a bottom side. In one embodiment, a heat resistant iron dock 16 is mounted at the top of the accessory compartment 18. In one embodiment, as illustrated in the figures, accessory compartment 18 includes several shelves, which may be used to store items regularly used when ironing. In another embodiment, the accessory compartment includes a bar to hang clothes from. Such bar may fold or telescope out to extend beyond the boundaries of cabinet 14. Two roller tracks 20 (only one illustrated in FIG. 1) guide roller frame 22 that is attached to board frame 24 located on the bottom side of the ironing board 12 (see FIG. 2). In one embodiment, as illustrated in the figures, board frame 24 has two support beams or rails. Optionally, at least one cross-member joins the two support beams or rails. In another embodiment, support frame 24 is one piece. Latch pin 26 mounts under ironing board 12 and is connected together with latch release 30. In one embodiment, as illustrated in the figures, latch pin 26 is parallel and in between the two support beams of support frame 24. In one embodiment, as illustrated in the figures, latch pin 26 and latch release 30 are one continuous length. Spring 32 engages latch pin 26 into strike plate 28. In other embodiments, spring 32 may be replaced with a different system for keeping the latch pin 26 in strike plate 28, for example, a lever lock or rotating lever lock. In one embodiment, latch pin 26 engages in a depression or hole in strike plate 28. In another embodiment, latch pin 26 engages with a flange on strike plate 28. In another embodiment, strike plate 28 has multiple locations in which latch pin 26 engages to allow for a use to adjust the height of the ironing board. Stop bumpers 34 (only one illustrated in FIG. 1) limit the distance of travel of rollers 38 (only one illustrated in FIG. 1) in roller tracks 20. In one embodiment, the location of stop bumper 34 is adjustable to allow a user to adjust the height of the ironing board. Rollers 38 are attached to roller frame 22. In pull-out cabinet embodiments, stability latch 36 locks the cabinet 14 in the open position when being used. Two support legs 40 attach to two leg base brackets 44 and apex bracket 42 (see FIG. 2) in a manner that allows the legs to pivot at the attachment points. The base brackets 44 are attached to the bottom of cabinet 14 and the apex bracket is attached to the bottom side of ironing board 12. In the adjustable height embodiments, the location of the apex bracket is adjustable. The two board support legs 40 pivot on two base pivot pins 46 and apex pivot pin 48 (see FIG. 2).

In the pull-out embodiment, cabinet 14 mounts to base mount 50 which is attached to and rides on base slide 52. Top slide 54 is located at the top of pull-out cabinet 14. In one embodiment, cord hook 56 is attached to the inside of cabinet 14 near iron dock 16.

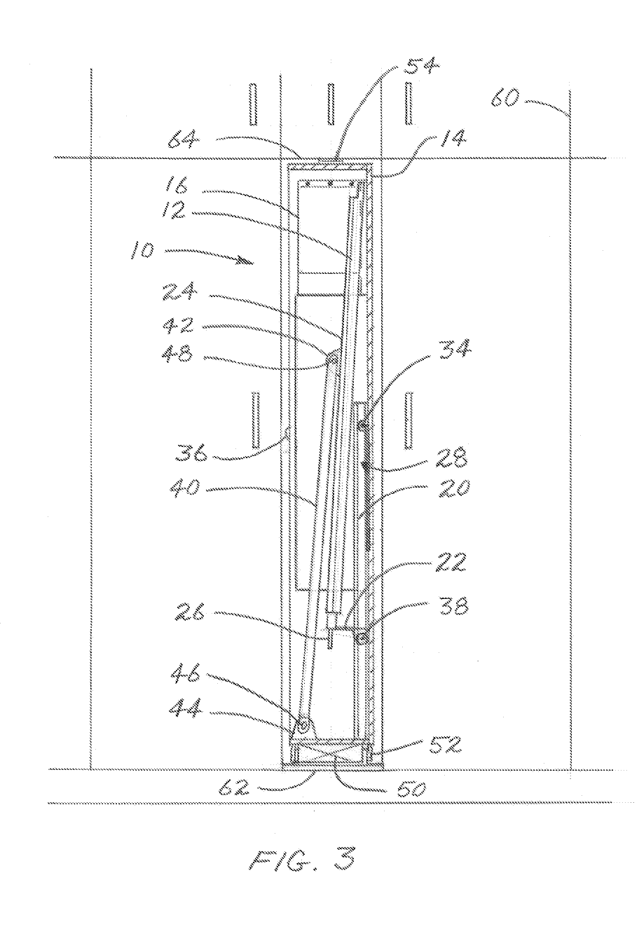

FIG. 3 illustrates the pull-out embodiment of ironing center 10 as it is installed in typical wall cabinets 60. Base slides 52 are fastened to the bottom 62 of wall cabinets 60 and top slide 54 is fastened to top 64 of compartment in wall cabinets 60. A door panel 66 and handle 68 would typically be applied to the pull-out cabinet 14 to conceal ironing center 10 within typical wall cabinets 60 and facilitate easy access to the ironing center 10.

FIG. 1 illustrates the pull-out embodiment of the ironing center as it would be used after having been withdrawn from its closed position within a cabinet, stability latch set and ironing board deployed.

The pull-out feature of the present invention overcomes space and aesthetic issues by fitting into a wall or wall cabinet in a sideways configuration. This arrangement enables the ironing center to be completely contained behind a very narrow door. In one embodiment, the door panel is less than 18 inches wide. In another embodiment, the door panel is less than 12 inches wide. In yet another embodiment, the door panel is less than 10 or 8 or 6 inches wide.

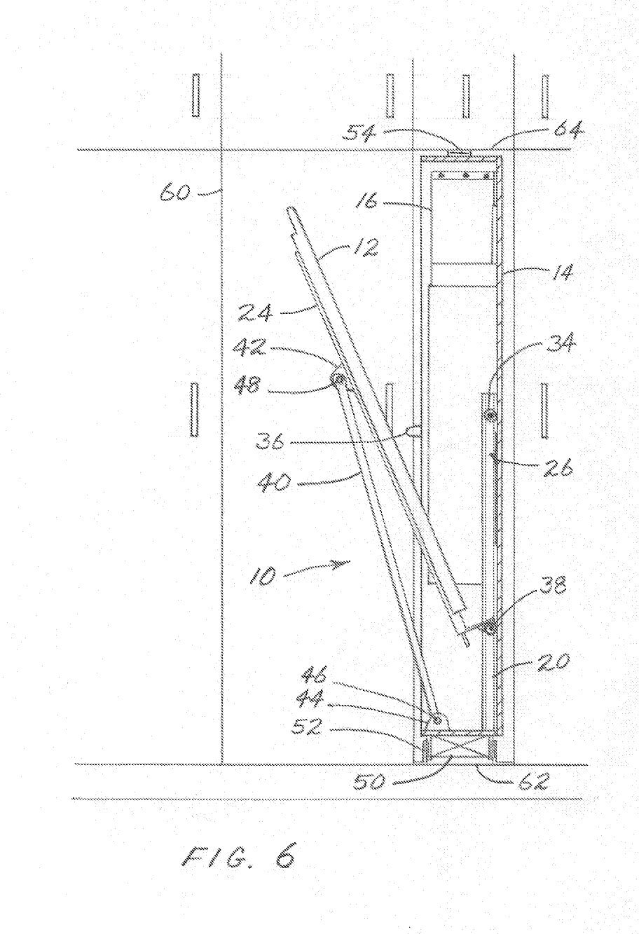

Once the ironing center cabinet is pulled out into the room it is latched into a stationary position by applying a stability latch 36 and then pulling the top of the ironing board 12 forward and the bottom up until latch pin 26 catches on strike plate 28 (see FIG. 6).

To put the pull-out ironing center away the user will pull the latch release 30 and move the extended end of the ironing board 12 upward and into the pull-out cabinet 14. Release the stability latch 36 and return the whole unit back into the stored position within the wall cabinet where it will blend in seamlessly with other adjacent cabinetry.

One objective of the present invention is to provide the consumer with a compact, space efficient and very convenient complete ironing center that can be an accessory cabinet component integrated into cabinetry.

In the preferred embodiment this pull-out ironing center will be sized to contain a full size ironing board and spaces for storage of ironing accessories and an iron dock for safe storage of and a convenient location for a standard household iron.

Furthermore, it is an object of this application to illustrate the preferred embodiments and broadly state the methodologies that may be used in order to facilitate the assemblies of a complete ironing center into a narrow portion of wall cabinets.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

What is claimed:

1. An ironing center assembly, comprising:
a cabinet having a first side, a second side, a top, a bottom, and a back; wherein the first side, the second side, the top, the bottom, and the back form a compartment having an interior side and an exterior side;
an ironing board having a top surface, a bottom surface, a top end, and a bottom end;
a board frame;
two support legs each having a first end and a second end;
two base brackets;
an apex bracket;
two roller tracks, each having a stopper;
a roller frame having a first end and a second end;
a latch system comprising a latch pin having a first end and a second end and a strike plate;
a top slide mounted to the exterior side of the top of the cabinet;
a bottom slide mounted to the exterior side of the bottom of the cabinet; and
a stability latch;
wherein the two roller tracks are mounted to the interior side of the first side and to the interior side of the second side of the cabinet;
wherein the strike plate is attached to the interior side of the back of the cabinet;
wherein the two base brackets are mounted to the interior side of the bottom of the cabinet;
wherein the board frame, the apex bracket, and the latch pin are attached to the bottom surface of the ironing board;
wherein the first end of the roller frame slideably engages with the two roller tracks and wherein the stopper limits the upward movement of the roller frame;
wherein the second end of the roller frame is attached to the board frame;
wherein the first end of the two support legs are attached to the two base brackets in a manner that allows the two support legs to pivot at the attachment point;
wherein the second end of the two support legs are attached to the apex bracket in a manner that allows the two support legs to pivot at the attachment point;
wherein the first end of the latch pin removeably engages with the strike plate;
wherein the second end of the latch pin forms a handle;
wherein the top slide and the bottom slide allow the cabinet to slide in and out of a larger second cabinet; and
wherein the stability latch stops the cabinet from sliding into the larger second cabinet.

2. The ironing center assembly of claim 1, further comprising a heat resistant iron dock attached to the interior surface of the cabinet.

3. The ironing center assembly of claim 1, further comprising at least two shelves.

4. The ironing center assembly of claim 1, further comprising a bar to hang clothing.

5. The ironing center assembly of claim 1, further comprising a cord hook.

6. The ironing center assembly of claim 1, wherein the first side and the second side of the cabinet has a width of less than 18 inches.

7. The ironing center assembly of claim 1, wherein the first side and the second side of the cabinet has a width of less than 12 inches.

8. The ironing center assembly of claim 1, wherein the ironing board is standard size.

9. The ironing center assembly of claim 1 wherein the cabinet is made of wood.

10. The ironing center assembly of claim 1 wherein the cabinet is made of metal.

11. The ironing center assembly of claim 1 wherein the cabinet is made of plastic.

12. A method for ironing comprising the steps of:
accessing the ironing center assembly of claim 1;
engaging the stability latch;
extending the ironing board by pulling the top end down and lifting the bottom end up;
engaging the latch system; and
ironing on the top surface of the ironing board.
